(19) United States
(12) Patent Application Publication
(10) Pub. No.: US 2012/0243649 A1
(43) Pub. Date: Sep. 27, 2012

(54) IN-REACTOR WORK SYSTEM AND IN-REACTOR WORK METHOD

(75) Inventors: Mitsuaki SHIMAMURA, Saitama (JP); Yutaka Togasawa, Kanagawa (JP); Hisashi Hozumi, Tokyo (JP); Kenji Matsuzaki, Tokyo (JP); Yasuhiro Yuguchi, Kanagawa (JP)

(73) Assignee: KABUSHIKI KAISHA TOSHIBA

(21) Appl. No.: 13/489,963

(22) Filed: Jun. 6, 2012

Related U.S. Application Data
(63) Continuation-in-part of application No. PCT/JP2010/007184, filed on Dec. 10, 2010.

(30) Foreign Application Priority Data
Dec. 10, 2009 (JP) 2009-280237

(51) Int. Cl. G21C 17/08; G21C 19/02

(52) U.S. Cl. 376/249; 376/260

(57) ABSTRACT

According to an embodiment, an in-reactor operation system which is provided with a crack detection vehicle that moves in a circumferential direction along an outer surface of a shroud disposed in a reactor pressure vessel with the axis vertical, an inspection/check sensor that is mounted on the crack detection vehicle and performs an operation with respect to the shroud, a vehicle positioning mast for setting an initial position of the crack detection vehicle on the shroud, a vehicle fixation mechanism for attaching and detaching the crack detection vehicle to and from the vehicle positioning mast, and a conveyance vehicle for conveying the vehicle positioning mast on which the crack detection vehicle is mounted into the reactor pressure vessel.

### CROSS-REFERENCE TO RELATED APPLICATIONS

This application is a continuation-in-part (CIP) application based upon the International Application PCT/JP2010/007184, the International Filing Date of which is Dec. 10, 2010, the entire content of which is incorporated herein by reference, and claims the benefit of priority from Japanese Patent Application No. 2009-280237, filed Dec. 10, 2009; the entire content of which is incorporated herein by reference.

### FIELD

The embodiments described herein relate to systems and methods for performing, in a nuclear power plant, various works such as cleaning, checkout, inspection, preventive maintenance, repair, and the like of an in-reactor structure such as a shroud installed within a reactor and a work method thereof.

### BACKGROUND

Here, a description is made by taking as an example a checkout and inspection of weld lines on a shroud, the work being performed in an underwater environment inside the reactor during reactor shutdown with the upper portion of a reactor pressure vessel opened. The checkout and inspection of the weld lines on a shroud in the underwater environment inside the reactor is required to be performed in parallel with fuel exchange for the purpose of shortening of work hours and cost reduction, and advantages in terms of work hours, inspection range, and cost are required.

As a method of remotely/automatically performing such works as checkout and inspection of the shroud, there have been proposed methods that use a mechanical transferring means such as a guide for positioning of a work device.

For example, in Japanese Patent Application Laid-Open Publication No. 2007-309788 (Patent Document 1), the entire content of which is incorporated herein by reference, in order to circumferentially move a work device on a shroud support plate in an annulus portion outside a reactor shroud, a tow rope is operated from a work carriage at the reactor upper portion to move the work device.

In Japanese Patent Application Laid-Open Publication No. 2004-294373 (Patent Document 2), the entire content of which is incorporated herein by reference, a core spray pipe in a reactor is used as a guide to horizontally move a work device to support monitoring and the like for in-reactor check and inspection works during fuel exchange without using a fuel exchanger.

In Japanese Patent Application Laid-Open Publication No. 8-201573 (Patent Document 3), the entire content of which is incorporated herein by reference, a work device is movably installed around a reactor shroud such that an access arm vertically suspended along the outside of a reactor shroud is mounted on a circumferentially traveling carriage installed at the upper portion of the reactor shroud.

Conventionally, in checkout and inspection of the weld lines on a shroud which is a main structural part of a reactor, a worker operates a vehicle or access device for checkout and inspection from a fuel exchanger or a work carriage, and the worker himself or herself conducts the checkout and inspection work while performing positioning to a target weld line or monitors operating state. This may result in a variation of work hours, as well as work delay.

Further, the shroud checkout and inspection work is required to be performed in parallel with fuel exchange for the purpose of shortening of work hours and cost reduction, and shorter work hours, wider inspection range, and lower cost are required for a work system performing the checkout and inspection work.

However, in the method described in Patent Document 1 in which the tow rope or a movement guide is installed in the fuel exchanger or work carriage at the reactor upper portion, the fuel exchanger or work carriage is indispensable during the inspection, so that it seems that this method is unsuitable for parallel work with the fuel exchange. Further, it seems that this work carriage cannot be applied to the weld lines on the shroud because it moves on the shroud support plate.

In the method described in Patent Documents 2 and 3, in which the work device is moved using the in-reactor structure such as a shroud upper trunk as a guide, the work device needs to be mounted to the leading end of an expansible/contractable structure such as a mast and be moved while avoiding jet pumps installed around the shroud, requiring a change in the installation position of the device, which may increase working hours.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a view schematically illustrating a state where a first embodiment of an in-reactor work system according to the present invention is installed inside a reactor;

FIG. 2 is an enlarged view of a crack detection vehicle of FIG. 1 as viewed from the rear side thereof;

FIG. 3 is a configuration view illustrating a fixed arm of FIG. 1 in an enlarged manner;

FIG. 4 is an enlarged view of a developing portion of FIG. 1;

FIG. 5 is an enlarged view illustrating a vehicle housing portion of FIG. 1;

FIG. 6 is a conceptual view illustrating a layout of composite cables in the case where the crack detection vehicle of FIG. 1 is positioned at substantially the center of the vehicle positioning mast and where the crack detection vehicle is not horizontally moved;

FIG. 7 is a conceptual view illustrating a layout of composite cables in the case where the crack detection vehicle of FIG. 1 is positioned at substantially the center of the vehicle positioning mast and where the crack detection vehicle is horizontally moved;

FIG. 8 is a conceptual view illustrating a layout of composite cables in the case where the crack detection vehicle of FIG. 1 is positioned at the upper portion of the vehicle positioning mast and where the crack detection vehicle is not horizontally moved;

FIG. 9 is a conceptual view illustrating a layout of composite cables in the case where the crack detection vehicle of FIG. 1 is positioned at the upper portion of the vehicle positioning mast and where the crack detection vehicle is horizontally moved;

FIG. 10 is a conceptual view illustrating a layout of composite cables in the case where the crack detection vehicle of FIG. 1 is positioned at the lower portion of the vehicle positioning mast and where the crack detection vehicle is not horizontally moved;

FIG. 11 is a conceptual view illustrating a layout of composite cables in the case where the crack detection vehicle of FIG. 1 is positioned at the lower portion of the vehicle positioning mast and where the crack detection vehicle is horizontally moved;

FIG. 12 is a view schematically illustrating, in a state where the first embodiment of the in-reactor work system according to the present invention is installed in the reactor, the installation position of the vehicle positioning mast as viewed from above the reactor;

FIG. 13 is an enlarged view illustrating the vehicle housing portion in which a signal multiplexing unit is disposed in a second embodiment of the in-reactor work system according to the present invention;

FIG. 14 is a view schematically illustrating a state where a third embodiment of the in-reactor work system according to the present invention is installed inside the reactor;

FIG. 15 is an enlarged view illustrating the crack detection vehicle in a fourth embodiment of the in-reactor work system according to the present invention as viewed from the rear side thereof;

FIG. 16 is an enlarged view illustrating the crack detection vehicle in a fifth embodiment of the in-reactor work system according to the present invention as viewed from the rear side thereof;

FIG. 17 is an enlarged view illustrating the crack detection vehicle in a sixth embodiment of the in-reactor work system according to the present invention as viewed from the rear side thereof;

FIG. 18 is an enlarged view illustrating the crack detection vehicle in a seventh embodiment of the in-reactor work system according to the present invention as viewed from the rear side thereof;

FIG. 19 is an enlarged view illustrating the crack detection vehicle in an eighth embodiment of the in-reactor work system according to the present invention as viewed from the rear side thereof; and

FIG. 20 is an enlarged view illustrating the crack detection vehicle in a ninth embodiment of the in-reactor work system according to the present invention as viewed from the rear side thereof, in which FIG. 20(a) illustrates a normal state, and FIG. 20(b) a reversed state.

### DETAILED DESCRIPTION

The present embodiments have been made to solve the above problems, and an object thereof is to provide an in-reactor work system and an in-reactor work method capable of performing, at short time periods, wide-range checkout and inspection of shroud weld lines during fuel exchange without the need for any human work such as device positioning or operation monitoring (automatic accessibility) and without the need for a crane or work carriage, to contribute to work saving in a periodic check process.

In order to achieve the above-mentioned object, according to an embodiment, there is provided an in-reactor work system comprising: a traveling mechanism traveling in a circumferential direction along an outer surface of a cylindrical structure which is disposed inside a reactor pressure vessel with its axis oriented in the vertical direction; a work unit mounted in the traveling mechanism and performing work for the cylindrical structure; an installation unit setting an initial position of the traveling mechanism on the cylindrical structure; a mounting/removing mechanism mounting/removing the traveling mechanism and installation unit to/from each other; and a carrying unit carrying the installation unit mounting the traveling mechanism inside the reactor pressure vessel, the installation unit being capable of setting the traveling mechanism at the initial position in such a manner as to rotatably change an attitude of the traveling mechanism about a given horizontal axis depending on whether the traveling mechanism at the initial position on the surface of the cylindrical structure moves in the clockwise or counterclockwise direction.

In order to achieve the above-mentioned object, according to another embodiment, there is provided an in-reactor work method that performs work, during shutdown of a nuclear reactor in which a cylindrical structure disposed inside a reactor pressure vessel with its axis oriented in the vertical direction, by making a work unit mounted in a traveling mechanism travel along an outer wall surface of the cylindrical structure, the method comprising: a carrying step of carrying the installation unit removably mounting the traveling mechanism from above the reactor pressure vessel in a state where the upper portion of the reactor pressure vessel is opened and the reactor pressure vessel is filled with water; a setting step of setting an initial position of the traveling mechanism on the outer wall surface of the cylindrical structure; a removing/mounting step of removing/mounting the traveling mechanism from the installation unit; and a working step of allowing the work unit to perform work by making the traveling mechanism travel along the outer surface of the cylindrical structure.

According to the embodiments, it is possible to perform, at short times, wide-range checkout and inspection of shroud weld lines during fuel exchange without the need for a crane or work carriage and without the need for any human work such as device positioning or operation monitoring (i.e. automatically accessible), to contribute to work saving in a periodic check process.

Embodiments of the present invention will be described below with reference to the accompanying drawings.

### First Embodiment

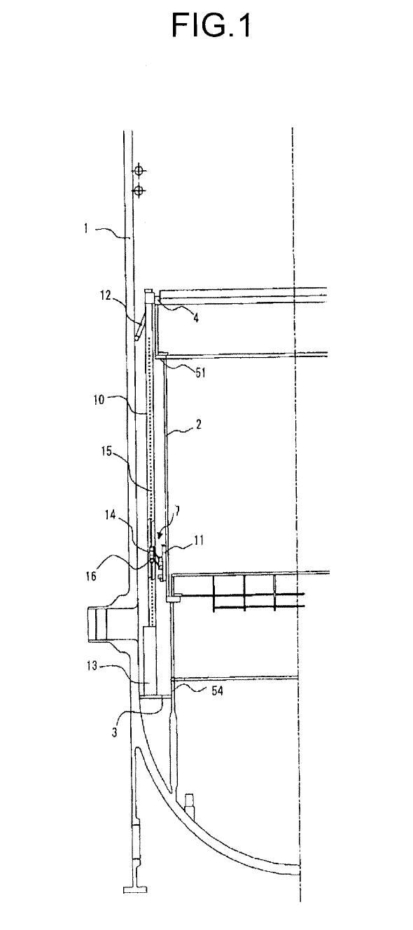

FIG. 1 is a view schematically illustrating a state where a first embodiment of an in-reactor work system according to the present invention is installed inside a reactor.

In FIG. 1, there is installed in a reactor pressure vessel 1a shroud 2 which is a cylindrical welded structure with its axis extending vertically. A shroud support plate 3 which is a hollow disk shaped structure extending horizontally is installed below and outside the shroud 2. A vehicle positioning mast 10 is installed at the annulus portion on the shroud support plate 3.

A fixed arm 12 is provided at a shroud upper ring 4 and the reactor pressure vessel 1 at the upper portion of the vehicle positioning mast 10, and a vehicle housing portion 13 is provided at the lower portion of the vehicle positioning mast 10.

In a developing portion 7 of the vehicle positioning mast 10, a crack detection vehicle 11 performing checkout and inspection of horizontal weld lines on the shroud 2 is connected to the vehicle positioning mast 10 by a developing arm 16 through a vehicle attachment/detachment portion to be described later. Further, an elevating base 14 is disposed so as to be moved up and down by an elevation guide 15 inside the vehicle positioning mast 10.

The following describes a procedure of performing the checkout and inspection of the horizontal weld lines on the shroud 2 by using the vehicle positioning mast 10 and a crack detection vehicle 11.

The crack detection vehicle 11 is installed on the shroud support plate 3 by means of a not illustrated underwater hoist and a not illustrated overhead crane in a state where it is housed in the vehicle housing portion 13 of the vehicle positioning mast 10.

The fixed arm 12 is developed with respect to the reactor pressure vessel 1, and its reaction force is received at the shroud upper ring 4 to thereby fix the vehicle positioning mast 10 at its upper portion.

After the installation process, the elevating base 14 is moved along the elevation guide 15 to move the crack detection vehicle 11 to the position of the horizontal weld line, and a developing arm 16 is used to press the crack detection vehicle 11 against the outer circumference of the shroud 2, to thereby determine the initial position at which the crack detection vehicle 11 starts moving.

As described later, the crack detection vehicle 11 is adsorbed to the vertical wall of the shroud 2 and can travel in the horizontal direction by itself. After completion of the above-described initial position setting, the crack detection vehicle 11 is separated from the developing arm 16 side by a vehicle attachment/detachment portion to be described later and performs checkout and inspection of the weld line using a checkout/inspection sensor mounted therein such as a visual inspection camera, a volumetric inspection ultrasonic crack detection sensor, or an eddy-current inspection sensor, while traveling along the horizontal weld line.

By mounting a desired working means in the crack detection vehicle 11, it is possible to perform polishing or cleaning work using a brush, a polishing jig, or a water cleaning nozzle, preventive maintenance work using a water jet peening head or a laser peening head, and repair work using a welding head or a grinding jig, as well as the checkout and inspection.

The following describes more in detail the crack detection vehicle 11.

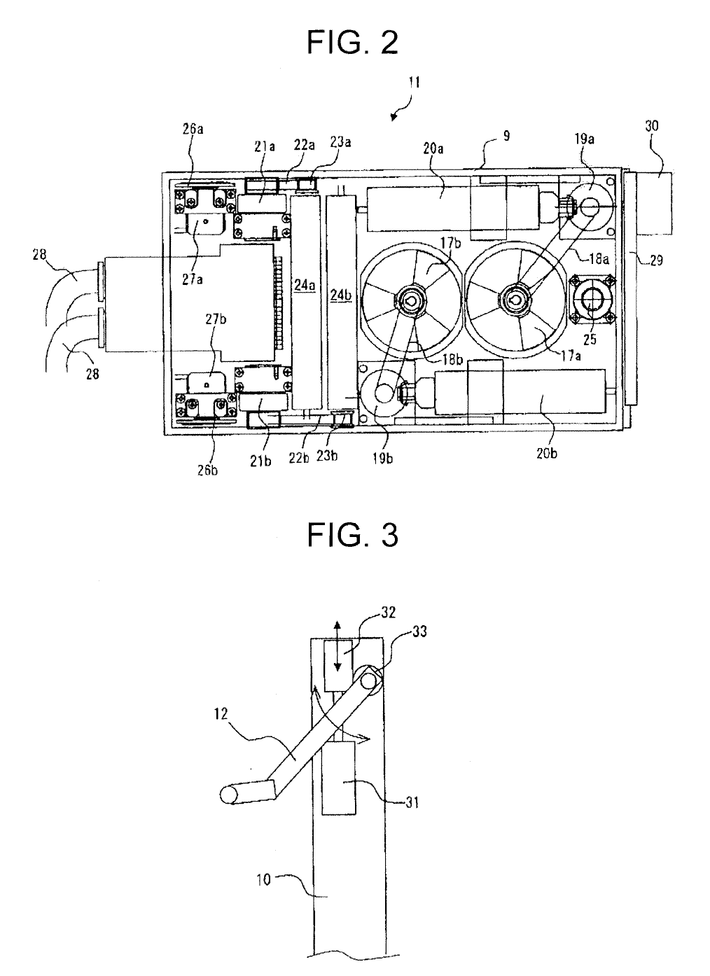

FIG. 2 is an enlarged view of the crack detection vehicle of FIG. 1 as viewed from the rear side thereof.

The crack detection vehicle 11 has two thrusters 17a and 17b and is covered by a frame body 9 excluding the two thrusters 17a and 17b. The thrusters 17a and 17b are connected to thruster motors 20a and 20b, respectively, through a timing belt 18a and a bevel gear 19a and through a timing belt 18b and a bevel gear 19b, and are rotatably driven by the thruster motors 20a and 20b.

The crack detection vehicle 11 has two traveling wheels 21a and 21b disposed on the left side of the drawing. The traveling wheels 21a and 21b are connected to wheel drive motors 24a and 24b, respectively, through a timing belt 22a and a timing pulley 23a and through a timing belt 22b and a timing pulley 23b, and are rotatably driven by the wheel drive motors 24a and 24b.

The crack detection vehicle 11 contacts the shroud wall surface at three points: the traveling wheel 21a, the traveling wheel 21b, and a caster wheel 25 thereby maintaining a distance between itself and the shroud wall surface constant. The horizontal travel distance is converted into the number of rotations of distance measurement wheel 26a and that of distance measurement wheel 26b, which are detected by distance measurement sensors 27a and 27b, respectively.

Cables of the above-mentioned sensors and motors are bundled into two composite cables 28, which are connected to the vehicle positioning mast 10 of FIG. 1, and finally to a control device installed on, e.g., an operation floor. The checkout/inspection sensor 30 is connected to the crack detection vehicle 11 through a movable guide 29.

After the initial position setting has been completed by the vehicle positioning mast 10 of FIG. 1, the crack detection vehicle 11 rotates the thrusters 17a and 17b to generate a flow from the shroud 2 wall surface side (suction side) thereof and rear side thereof (discharge side). As a result, a pressure of the crack detection vehicle 11 on the shroud 2 wall surface side becomes lower than that on the rear side, thereby allowing the crack detection vehicle 11 to be adsorbed to the shroud 2 wall surface. In this state, by rotatably driving the traveling wheels 21a and 21b in the same direction with respect to the crack detection vehicle 11, the crack detection vehicle 11 can travel on the shroud 2 in either right or left direction.

Even if the traveling wheel 21a or traveling wheel 21b slips, the horizontal travel distance is directly detected by the distance measurement wheels 26a and 26b, so that an actual movement state can be detected.

When one of the traveling wheels 21a and 21b slips, the crack detection vehicle 11 is tilted, which may cause the checkout/inspection sensor 30 to be displaced upward or downward. For example, when the checkout/inspection sensor 30 is displaced upward while traveling to the right in the state of FIG. 2, the travel distance measured by the measurement wheel 26b becomes larger than that measured by the measurement wheel 26a. In this case, the difference between the travel distances is detected, and then the rotation speed of the traveling wheel 21b is reduced relative to that of the traveling wheel 21a to perform adjustment control such that the crack detection vehicle 11 levels off, thereby achieving attitude correction. Conversely, when the checkout/inspection sensor 30 is displaced downward, rotation speed of the traveling wheel 21b is increased relative to that of the traveling wheel 21a to thereby achieve attitude correction.

FIG. 3 is a configuration view illustrating the fixed arm 12 of FIG. 1 in an enlarged manner.

In FIG. 3, a rack 32 is attached to the leading end of an air cylinder 31, and the fixed arm 12 is connected to the rack 32 through a pinion gear 33.

Moving up/down the rack 32 by the air cylinder 31 can rotate the pinion gear 33 and the fixed arm 12. This operation allows the fixed arm 12 of FIG. 1 to be housed inside the vehicle positioning mast 10 or to be developed outward. When being developed, the fixed arm 12 is pressed against the inner surface of the reactor pressure vessel 1, and its reaction force is received at the shroud upper ring 4 to thereby fix the upper portion of the vehicle positioning mast 10.

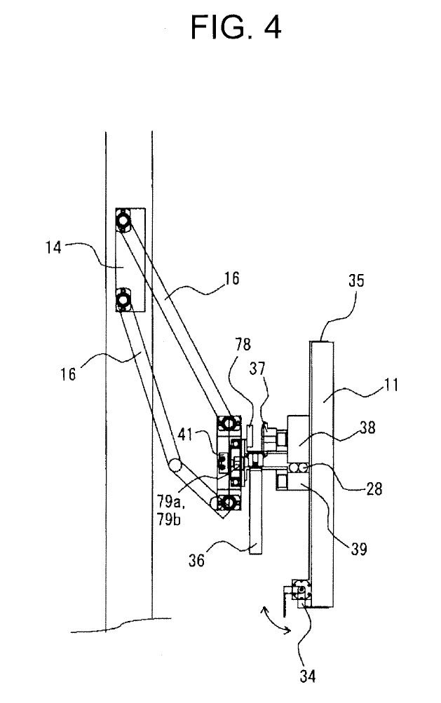

FIG. 4 is an enlarged view of the developing portion 7 of FIG. 1.

In FIG. 4, the crack detection vehicle 11 is arranged such that the longitudinal axis thereof is vertically oriented and fixed to and retained to a vehicle fixing bracket 35 by a vehicle fixing mechanism 34. On the vehicle fixing bracket 35, a cable length adjusting pulley 38 for feeding and withdrawal of the composite cable 28 and an idler roller 39 for sandwiching the composite cable 28 between itself and cable length adjusting pulley 38 are disposed. The cable length adjusting pulley 38 is rotatably driven by a pulley drive motor 36 through a bevel gear 37.

The above crack detection vehicle 11, vehicle fixing bracket 35, vehicle fixing mechanism 34, cable length adjusting pulley 38, idler roller 39, bevel gear 37, and pulley drive motor 36 are all connected through a bearing mechanism to the developing arm 16 side by a vehicle rotating mechanism 41 so as to be rotated about the horizontal axis, that is, so as to be rotated in such a manner that the longitudinal end portions of the crack detection vehicle 11 are moved from the positions illustrated in FIG. 4 to 90-degree rotated positions on the near and far sides of the paper surface of FIG. 4.

Further, in FIG. 4, a detecting dog 78 is attached to the rotating side and is configured to be rotated following the 90-degree rotation of the longitudinal end portions of the crack detection vehicle 11 from the positions illustrated in FIG. 4 toward the near and far sides of the paper surface of FIG. 4. Further, proximity sensors 79a and 79b are attached to the fixed side connected with the developing arm 16. Thus, when the dog 78 is rotated by 90 degrees toward the near side of the paper surface, it is detected by the proximity sensor 79a; while when the detecting dog 78 is rotated by 90 degrees toward the far side of the paper surface, it is detected by the proximity sensor 79b. With the above operation, it is possible to detect a change in the orientation of the crack detection vehicle 11 to be installed on the shroud 2. The above components are connected to the vehicle positioning mast 10 side by the elevating base 14 and two developing arms 16.

The following describes more in detail a procedure of the checkout and inspection of the horizontal weld lines on the shroud 2 performed by the crack detection vehicle 11.

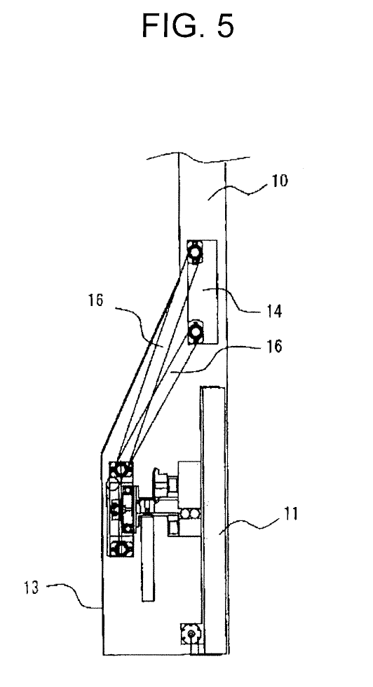

As illustrated in FIG. 5, the crack detection vehicle 11 is housed in the vehicle housing portion 13 provided at the lower portion of the vehicle positioning mast 10 in a state where the longitudinal axis thereof is vertically oriented.

After completion of installation of the vehicle positioning mast 10, the developing arms 16 are rotated by a not illustrated air cylinder or the like to develop the crack detection vehicle 11 to the shroud 2 side illustrated in FIG. 4 so as to move the crack detection vehicle 11 outside the vehicle positioning mast 10.

Subsequently, the crack detection vehicle 11 is rotated by 90 degrees by the vehicle rotating mechanism 41 to cause the longitudinal axis of the crack detection vehicle 11 to be oriented to the horizontal direction as illustrated in FIG. 2.

Then, the developing arms 16 are rotated to bring the crack detection vehicle 11 into contact with the outer surface of the shroud 2.

Thereafter, the crack detection vehicle 11 is adsorbed to the shroud 2 as described above, released from the vehicle fixing mechanism 34, and made to travel in the horizontal direction. When the travel direction needs to be reversed, the vehicle rotating mechanism 41 reverses the rotation direction of the crack detection vehicle 11.

Since vehicle positioning mast 10 is in a fixed state, it is necessary to adjust the length of the composite cables 28 according to the position of the crack detection vehicle 11. The travel distance of the crack detection vehicle 11 is measured by the measurement wheels 26a and 26b, and the cable length adjusting pulley 38 is rotated according to the measured distance to thereby adjust the length of the composite cables 28. As a result, a cable reaction force acting on the crack detection vehicle 11 is reduced to allow the crack detection vehicle 11 to perform horizontal travel motion stably, whereby correct crack detection work can be carried out.

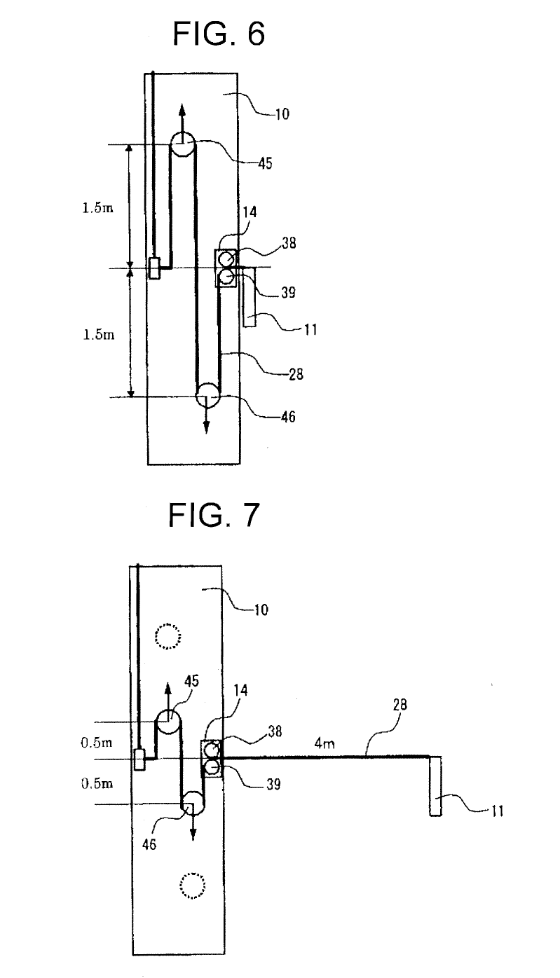

FIGS. 6 to 11 are conceptual views illustrating a layout of the composite cables 28 in the crack detection vehicle 11 according to the present embodiment.

FIGS. 6 and 7 each illustrate a layout of the composite cables 28 in the case where the crack detection vehicle 11 is positioned at substantially the center of the vehicle positioning mast 10, and the composite cables 28 are let out.

In FIG. 6, the composite cables 28 are routed in an S-like shape. An upper pulley 45 and a lower pulley 46 are pulled upward and downward by, e.g., a Conston Spring so that the composite cables 28 are not loosen. A distance between the pulleys is set to, e.g., 3 m.

When the crack detection vehicle 11 is horizontally moved by 4 m, the composite cables 28 are let out by the cable length adjusting pulley 38 and idler roller 39 to reduce the distance between the upper and lower pulleys 45 and 46 to, e.g., 1 m as illustrated in FIG. 7, whereby the composite cables 28 can be let out without loosening. When the composite cables 28 are set back to the state of FIG. 6, the loosening of the composite cables 28 in the vehicle positioning mast 10 can be avoided.

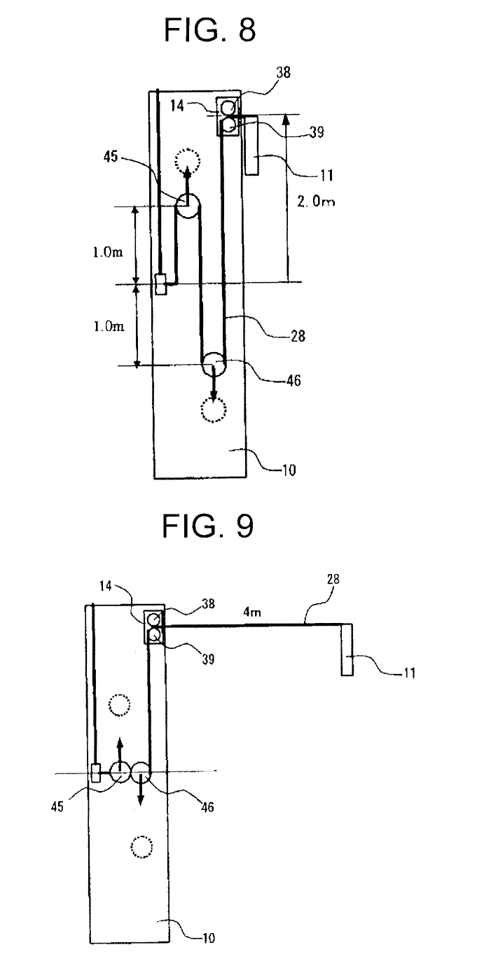

FIGS. 8 and 9 each illustrate a routing state of the composite cables 28 in the case it is let out and where the crack detection vehicle 11 is positioned at the upper portion of the vehicle positioning mast 10.

Also in FIG. 8, the composite cables 28 are routed in an S-like shape. The upper pulley 45 and lower pulley 46 are pulled upward and downward by, e.g., a Conston Spring so that the composite cables 28 are not loosen. The distance between the pulleys is set to, e.g., 2 m.

When the crack detection vehicle 11 is horizontally moved by 4 m, the composite cables 28 are fed by the cable length adjusting pulley 38 and idler roller 39 to reduce the distance between the upper and lower pulleys 45 and 46 to, e.g., 0 m as illustrated in FIG. 9, whereby the composite cables 28 can be let out without loosening. When the composite cables 28 are set back to the state of FIG. 8, the routing of the composite cables 28 without loosening in the vehicle positioning mast 10 can be performed.

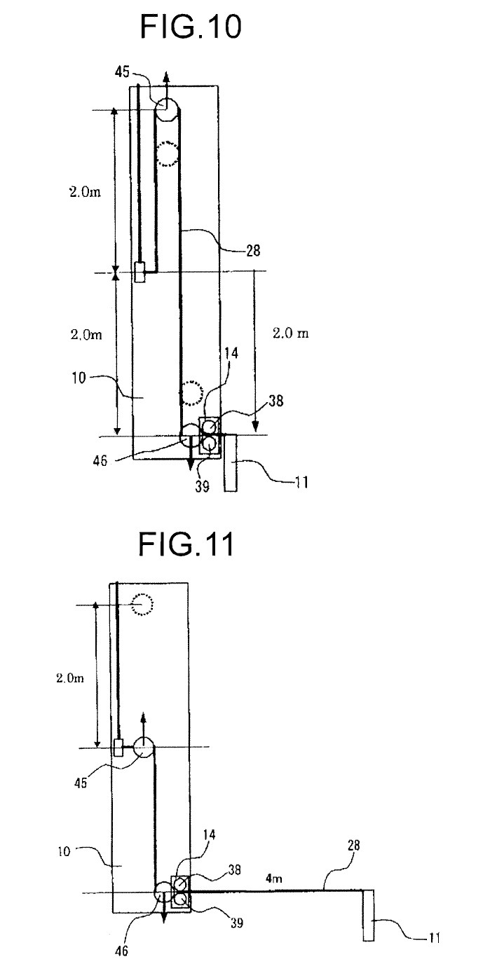

FIGS. 10 and 11 each illustrate a routing state of the composite cables 28 in the case it is let out and where the crack detection vehicle 11 is positioned at the lower portion of the vehicle positioning mast 10.

Also in FIG. 10, the composite cables 28 are routed in an S-like shape. The upper pulley 45 and lower pulley 46 are pulled upward and downward by, e.g., a Conston Spring so that the composite cables 28 are not loosen. The distance between the pulleys is set to, e.g., 4 m.

When the crack detection vehicle 11 is horizontally moved by 4 m, the composite cables 28 are let out by the cable length adjusting pulley 38 and idler roller 39 to descend the upper pulley 45 by, e.g., 2 m with the position of the lower pulley 46 kept unchanged as illustrated in FIG. 11, whereby the composite cables 28 can be let out without loosening. When the composite cables 28 are set back to the state of FIG. 10, the routing of the composite cables 28 without loosening in the vehicle positioning mast 10 can be performed.

As described using FIGS. 6 to 11, even when the position of the crack detection vehicle 11 is changed, the composite cables 28 can be run in the vehicle positioning mast 10 without loosening, and the lengths of the composite cables 28 can be adjusted with the movement of the crack detection vehicle 11.

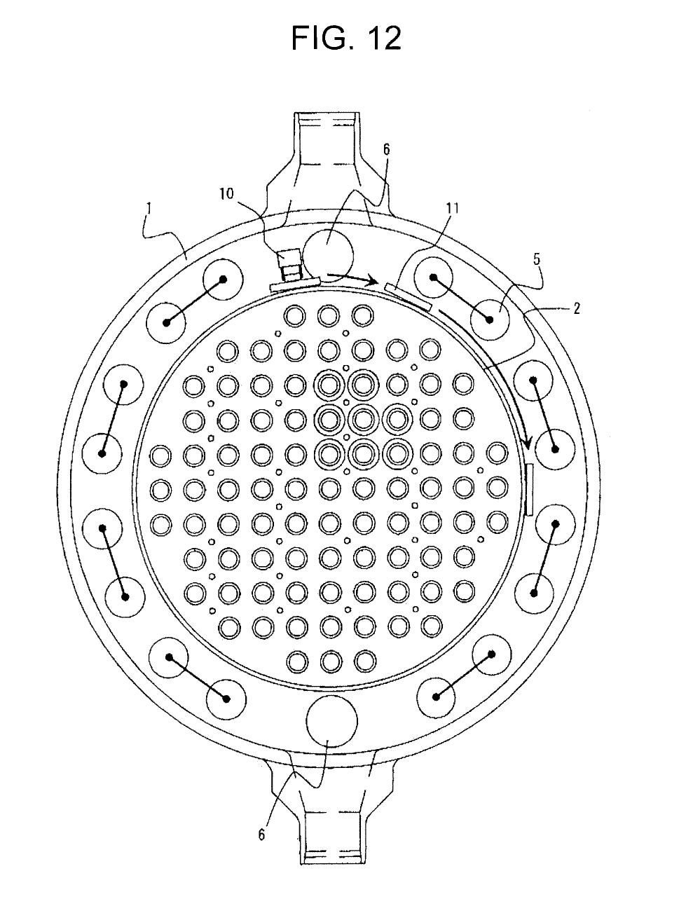

FIG. 12 is a view schematically illustrating the installation position of the vehicle positioning mast 10 as viewed from above the reactor.

In FIG. 12, the vehicle positioning mast 10 is installed beside an access hole cover 6. The crack detection vehicle 11 is rotated to be set on the outer surface of the shroud 2 as described above and is then made to travel inside jet pumps 5 along the weld line by 90 degrees in the CW (clockwise) direction as illustrated to perform the checkout and inspection of the shroud 2.

Subsequently, the crack detection vehicle 11 is returned to the vehicle positioning mast 10 and is then made to travel by 90 degrees in the CCW (counterclockwise) direction to perform the checkout and inspection of the shroud 2. As a result, the checkout and inspection for half the circumference of the shroud 2 are completed.

Then, the vehicle positioning mast 10 is installed beside the opposite access hole cover 6 positioned at the lower side of FIG. 12 to perform the checkout and inspection for the remaining half the circumference. As described above, the crack detection vehicle 11 can horizontally travel on the surface of the shroud 2 from its initial position in both clockwise and counterclockwise directions, so that the installation of the vehicle positioning mast 10 with respect to the shroud 2 only at two locations allows the checkout and inspection of the weld lines of whole circumference of the shroud 2 to be carried out.

Although the crack detection vehicle 11 can travel only in the horizontal direction in the present embodiment, it is possible to use a vehicle with traveling wheels having a steering function so as to travel also in the vertical direction, which allows crack detection of vertical weld lines.

As described above, according to the first embodiment of the in-reactor work system of the present invention, in performing the checkout and inspection of the weld lines on the shroud 2 during fuel exchange, an overhead crane or a work carriage is not used during the checkout and inspection of the weld lines, but the crack detection vehicle 11 is used to carry the checkout/inspection sensor 30 along the weld lines. Thus, wide-range checkout and inspection work can be achieved in a short time. Further, initial positioning can be achieved remotely and automatically to reduce uncertainty resulting from human work and further to reduce work time. This in turn contributes to work saving in a periodic check process.

Preferably, in order not to interfere with the movement of the crack detection vehicle 11, the cables 28 are connected to the crack detection vehicle 11 at the travel direction rear side thereof. In the present embodiment, the attitude of the crack detection vehicle 11 at its initial position can be reversed to allow the crack detection vehicle 11 to travel in both the clockwise and counterclockwise directions from the initial position without being interfered with by the cables 28.

### Second Embodiment

A second embodiment of the present invention will be described below.

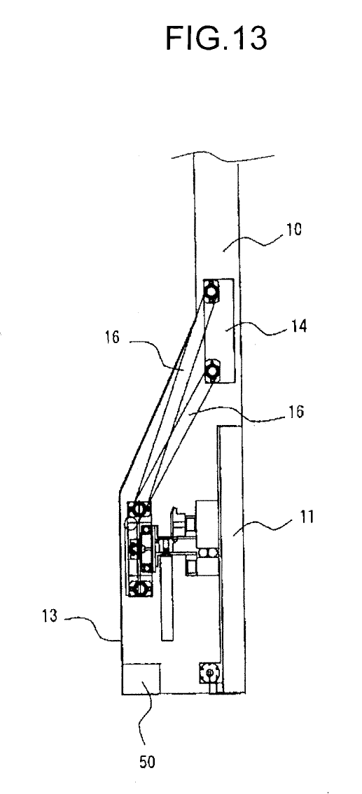

The second embodiment of the in-reactor work system according to the present invention has a similar configuration to the first embodiment except that a signal multiplexing unit 50 such as a multiplexer is disposed in the vehicle housing portion 13 at the lower portion of the vehicle positioning mast 10 as illustrated in FIG. 13.

The present embodiment can achieve the same effect as that in the first embodiment. Further, the number of cables can be reduced in installing the vehicle positioning mast 10 and the crack detection vehicle 11.

The reduction in the number of cables can in turn lead to a reduction in the number of workers required for the installation and transfer work and in work time, thus contributing to a shortening of the entire work period.

### Third Embodiment

A third embodiment of the present invention will be described below.

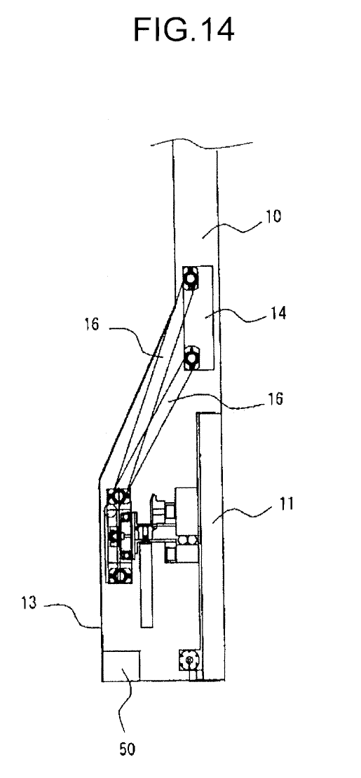

The third embodiment of the in-reactor work system according to the present invention uses, as a means for carrying the crack detection vehicle 11 and the vehicle positioning mast 10 inside the reactor pressure vessel 1, not the underwater hoist and the overhead crane in the first embodiment, but a carrying vehicle 52 that can travel underwater. That is, the vehicle positioning mast 10 and the crack detection vehicle 11 are carried by being hung from the carrying vehicle 52 to the position illustrated in FIG. 14.

Further, a tilt mechanism (not illustrated) that can be rotated about the two horizontal axes is disposed at a connection portion between the crack detection vehicle 11 and the vehicle positioning mast 10. With this tilt mechanism, even if the crack detection vehicle 11 and the vehicle positioning mast 10 are wholly tilted, the elongated vehicle positioning mast 10 can be inserted and installed in the narrow annulus portion.

According to the present embodiment, installation and movement of the vehicle positioning mast 10 and the crack detection vehicle 11 can be achieved without use of the overhead crane, thereby performing the checkout and inspection of the shroud 2 without interfering with another in-reactor work in a periodic check process.

### Fourth Embodiment

A fourth embodiment of the present invention will be described below.

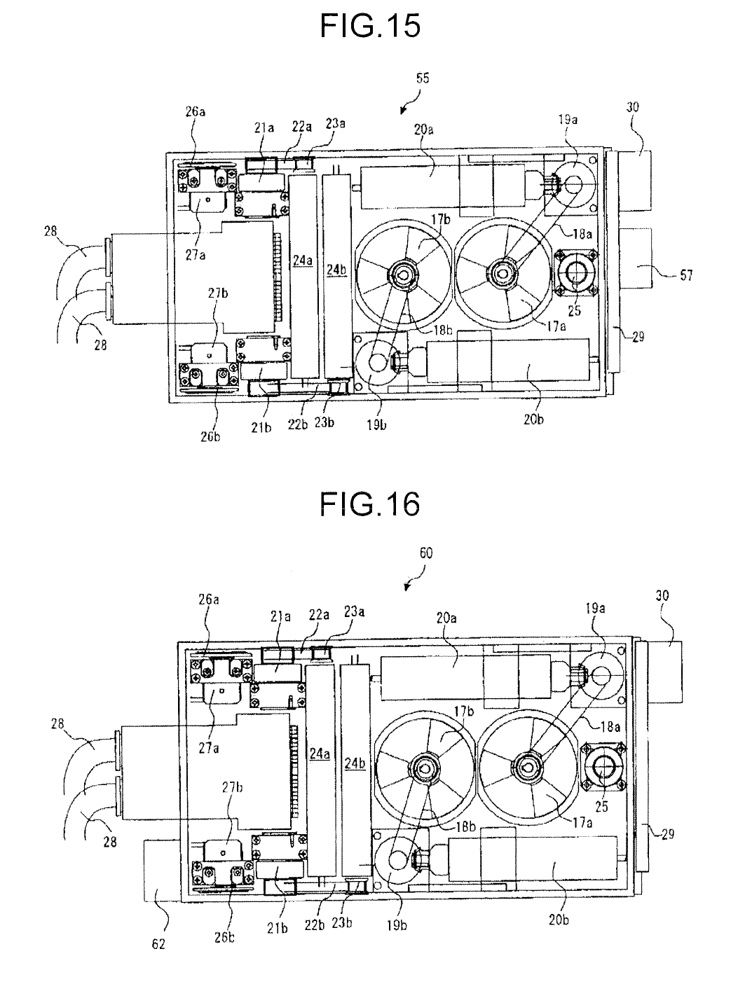

The fourth embodiment of the in-reactor work system according to the present invention uses a crack detection vehicle 55 having a similar configuration to the crack detection vehicle 11 of the first embodiment except that it is provided with a visual-camera 57 as illustrated in FIG. 15.

In the fourth embodiment, the visual camera 57 is used to sequentially acquire images of the surface of the shroud 2. Applying image processing to the acquired camera images detects vertical displacement with respect to the movement direction, whereby the rotation speeds of the two traveling wheels of the crack detection vehicle 55 are adjusted to correct the travel direction.

The present embodiment can achieve the same effect as that in the first embodiment. Further, even displacement in the direction perpendicular to the rotation direction of the two distance measurement wheels 26a and 26b can be detected and the non-contact detection of the travel displacement allows correction of the travel direction without giving disturbance to the movement of the crack detection vehicle 55. As a result, scanning accuracy of the checkout/inspection sensor 30 is increased to contribute to an increase in the accuracy of acquired data.

### Fifth Embodiment

A fifth embodiment of the present invention will be described below.

The fifth embodiment of the in-reactor work system according to the present invention uses a crack detection vehicle 60 having a similar configuration to the crack detection vehicle 11 of the first embodiment except that it is provided with a depth sensor 62 as illustrated in FIG. 16.

In the fifth embodiment, the depth sensor 62 is used to sequentially acquire water depth data during the horizontal travel. Vertical displacement with respect to the movement direction is detected based on the acquired water depth data, whereby the rotation speeds of the two traveling wheels of the crack detection vehicle 60 are adjusted to correct the travel direction.

The present embodiment can achieve the same effect as that in the first embodiment. Further, even displacement in the direction perpendicular to the rotation direction of the two distance measurement wheels 26a and 26b can be detected and the non-contact detection of the travel displacement allows correction of the travel direction without giving disturbance to the movement of the crack detection vehicle 60. As a result, scanning accuracy of the checkout/inspection sensor 30 is increased to contribute to an increase in the accuracy of acquired data.

### Sixth Embodiment

A sixth embodiment of the present invention will be described below.

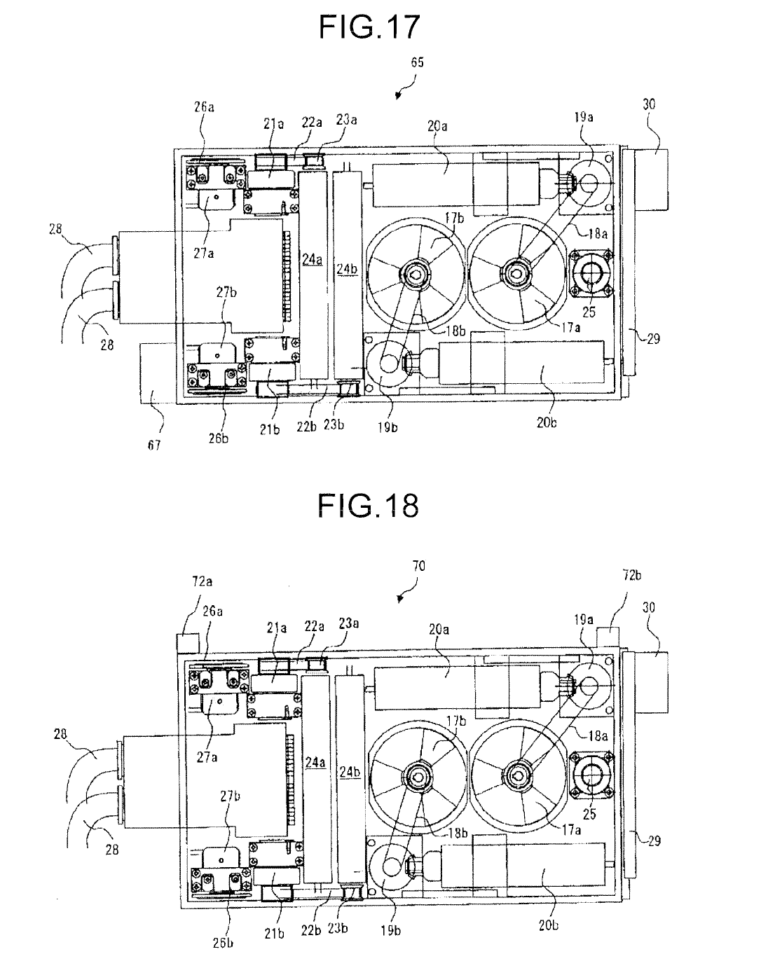

The sixth embodiment of the in-reactor work system according to the present invention uses a crack detection vehicle 65 having a similar configuration to the crack detection vehicle 11 of the first embodiment except that it is provided with an acceleration sensor 67 as illustrated in FIG. 17.

In the sixth embodiment, the acceleration sensor 67 is used to sequentially acquire sensor information representing vertical displacement with respect to the movement direction. The rotation speeds of the two traveling wheels of the crack detection vehicle 65 are adjusted based on the acquired displacement to correct the travel direction.

The present embodiment can achieve the same effect as that in the first embodiment. Further, even displacement in the direction perpendicular to the rotation direction of the two distance measurement wheels 26a and 26b can be detected and the non-contact detection of the travel displacement allows correction of the travel direction without giving disturbance to the movement of the crack detection vehicle 65. As a result, scanning accuracy of the checkout/inspection sensor 30 is increased to contribute to an increase in the accuracy of acquired data.

### Seventh Embodiment

A seventh embodiment of the present invention will be described below.

The seventh embodiment of the in-reactor work system according to the present invention uses a crack detection vehicle 70 having a similar configuration to the crack detection vehicle 11 of the first embodiment except that it is provided with two ultrasonic wave sensors 72a and 72b as illustrated in FIG. 18.

In the seventh embodiment, the crack detection vehicle 70 horizontally travels on the wall surface of the shroud 2 while measuring the distance from a lower surface 51 of an intermediate ring of the shroud 2 illustrated in FIG. 1 by means of the ultrasonic wave sensors 72a and 72b. Distances detected by the ultrasonic wave sensors 72a and 72b are sequentially acquired, vertical displacement with respect to the movement direction is detected from the detected distances, and the tiled angle of the crack detection vehicle 70 is calculated from a difference between the detected distances.

The rotation speeds of the two traveling wheels of the crack detection vehicle 70 are adjusted based on the acquired vertical displacement and tilted angle to correct the travel direction and tilted angle.

The present embodiment can achieve the same effect as that in the first embodiment. Further, even displacement in the direction perpendicular to the rotation direction of the two distance measurement wheels 26a and 26b can be detected and the non-contact detection of the travel displacement allows correction of the vehicle's travel direction and tilted angle without giving disturbance to the movement of the crack detection vehicle 70. As a result, scanning accuracy of the checkout/inspection sensor 30 is increased to contribute to an increase in the accuracy of acquired data.

### Eighth Embodiment

An eighth embodiment of the present invention will be described below.

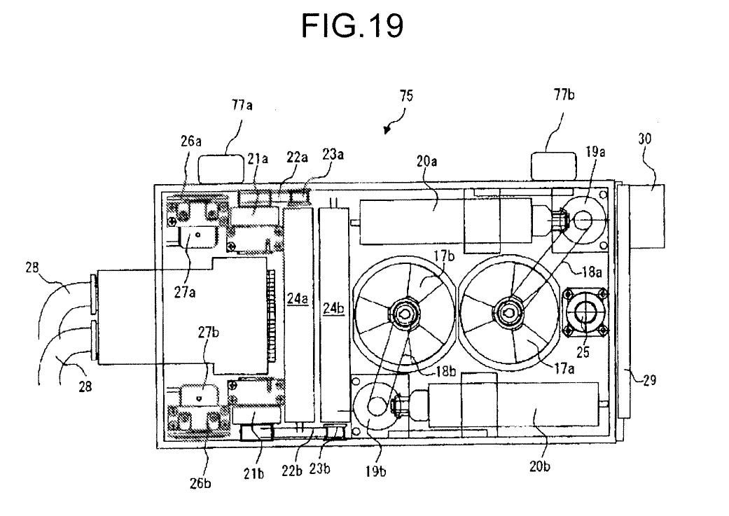

The eighth embodiment of the in-reactor work system according to the present invention uses a crack detection vehicle 75 having a similar configuration to the crack detection vehicle 11 of the first embodiment except that it is provided with two contact rollers 77a and 77b as illustrated in FIG. 19.

In the eighth embodiment, the crack detection vehicle 75 horizontally travels on the wall surface of the shroud 2 along the intermediate ring of the shroud 2 while brining the contact rollers 77a and 77h into contact with the lower surface 51 of the intermediate ring of the shroud 2. Giving an underwater buoyancy to the crack detection vehicle 75 causes the crack detection vehicle 75 to tend to ascend underwater, allowing the rollers to be brought into contact with the lower surface 51 of the intermediate ring. This contact of the rollers can prevent an occurrence of vertical displacement during horizontal travel.

Further, a configuration may be adopted in which contact rollers are disposed on the lower side of the crack detection vehicle 75 in FIG. 19 so as to allow the crack detection vehicle 75 to horizontally travel on the wall surface of the shroud 2 along a shroud support cylinder 54 while bring the rollers into contact with the upper surface of the shroud support plate 3 as illustrated in FIG. 1. In this case, by causing the crack detection vehicle 75 to tend to descend underwater, the rollers can be brought into contact with the upper surface of the shroud support plate 3 by its own underwater weight. As in the above case, this contact of the rollers can prevent an occurrence of vertical displacement during horizontal travel.

The present embodiment can achieve the same effect as that in the first embodiment. Further, vertical displacement during the movement in the horizontal direction with respect to the shroud 2 can be prevented, so that scanning accuracy of the checkout/inspection sensor 30 is increased. This in turn contributes to an increase in the accuracy of acquired data.

### Ninth Embodiment

The above fifth embodiment has been described concerning the crack detection vehicle 60 provided with the sensor capable of detecting the water depth even in the case where the vertical orientation of the crack detection vehicle is reversed. In the present embodiment, a crack detection vehicle 80 capable of detecting the water depth in the case where the vertical orientation thereof is reversed even when the travel direction thereof is changed from the left to right or vice versa.

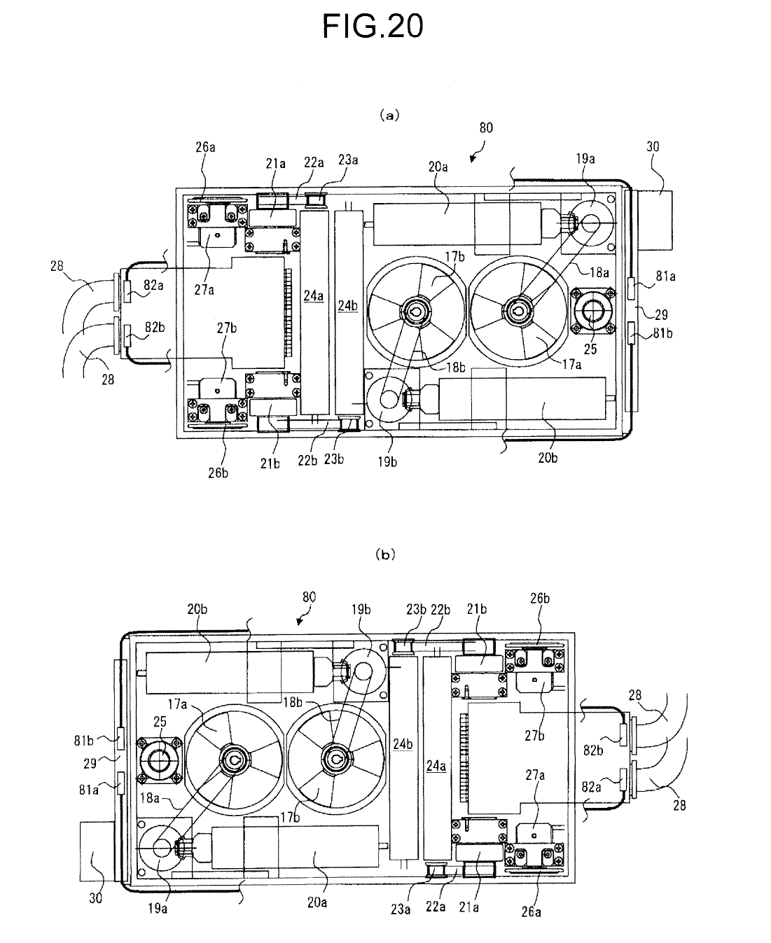

The ninth embodiment of the in-reactor work system according to the present invention uses a crack detection vehicle 80 having a similar configuration to the crack detection vehicle 11 of the first embodiment except that it is provided with a pair of air tubes 81a and 81b at one end of the vehicle body and a pair of air tubes 82a and 82b at the other end thereof as illustrated in FIGS. 20(a) and 20(b).

More specifically, as illustrated in FIG. 20(a), the air tube 81a having an opening opened downward and the air tube 81b having an opening opened upward are mounted to the right end of the crack detection vehicle 80. Further, the air tube 82a having an opening opened downward and the air tube 82b having an opening opened upward are mounted to the left end of the crack detection vehicle 80. These air tubes 81a, 81b, 82a, and 82b are used to detect water pressure.

When the crack detection vehicle 80 travels to the right in FIG. 20(a), a not illustrated pressure meter connected to the air tube 81a is used to detect the ambient water pressure. The vertical displacement with respect to the movement direction is detected based on the detected water depth data, and the rotation speeds of the two traveling wheels of the crack detection vehicle 80 are adjusted to correct the travel direction. Conversely, when the crack detection vehicle 80 travels to the left, a not illustrated pressure meter connected to the air tube 82a is used to detect the ambient water pressure, and the rotation speeds of the traveling wheels are adjusted to correct the travel direction.

In the case where the crack detection vehicle 80 is turned upside down as described in the first embodiment, when the crack detection vehicle 80 travels to the right as illustrated in FIG. 20(b), a not illustrated pressure meter connected to the air tube 82b is used to detect the ambient water pressure. The vertical displacement with respect to the movement direction is detected based on the detected water depth data, and the rotation speeds of the two traveling wheels of the crack detection vehicle 80 are adjusted to correct the travel direction. Conversely, when the crack detection vehicle 80 travels to the left, a not illustrated pressure meter connected to the air tube 81b is used to detect the ambient water pressure, and the rotation speeds of the traveling wheels are adjusted to correct the travel direction.

Since the air tube is used for detecting the water pressure in the present embodiment, water is intruded into the air tubes 81b and 82b whose openings are opened upward in FIG. 20(a). Accordingly, it is impossible to detect the water pressure when the vertical orientation of the crack detection vehicle 80 is reversed as illustrated in FIG. 20(b), so that air is applied to perform flushing to remove water before the water pressure detection.

Further, in the present embodiment, the water depth at a position prior to the traveling wheels 21a and 21b is detected so as to control the travel direction. When the crack detection vehicle 80 travels to the right in FIG. 20(a), the water pressure is detected using the air tube 81a, and if the vertical position of the crack detection vehicle 80 is lowered, the crack detection vehicle 80 is rotated in the CCW (counterclockwise) direction to correct the vertical position. As a result, the position of the air tube 81a is raised to detect the water pressure in the direction in which the vertical position of the crack detection vehicle 80 has been corrected. That is, the water pressure representing a state quantity after the correction is detected so as to cancel out a change in the water pressure representing a state quantity before the correction, thereby achieving stable control.

On the other hand, assume that the air tube 82a is used to detect the water pressure for the control when the crack detection vehicle 80 travels to the right in FIG. 20(a). In this case, if the vertical position of the crack detection vehicle 80 is lowered, the crack detection vehicle 80 is rotated in the CCW (counterclockwise) direction so as to correct the vertical position, with the result that the position of the air tube 82a is further lowered. This results in detection of the pressure of the water at the position in the opposite direction to the direction in which the vertical position of the crack detection vehicle 80 is corrected, which may result in unstable control as compared to the control using the air tube 81a. That is, the water pressure representing a state quantity after the correction is detected in such a direction so as to increase a change in the water pressure representing a state quantity before the correction, making the control unstable.

Further, in the present embodiment, not only the height in the vertical direction is detected based on the water pressure, but also the water pressure values detected by the air tubes 81a and 82a are compared to detect the tilted angle of the crack detection vehicle 80. Thus, displacement of the attitude can be detected with higher accuracy so as to correct the travel direction.

In the ninth embodiment described above, even displacement in the direction perpendicular to the rotation direction of the two distance measurement wheels can be detected and the non-contact detection of the travel displacement allows correction of the travel direction without giving disturbance to the movement of the crack detection vehicle 80. Further, the water depth at a position prior to the traveling wheels 21a and 21b is detected so as to control the travel direction, thereby achieving stable control. Further, the tilted angle of the crack detection vehicle 80 can also be detected. This in turn increases the scanning accuracy of the checkout/inspection sensor 30 to contribute to an increase in the accuracy of acquired data.

The correction control based on the detection results of the individual air tubes 81a, 81b, 82a, and 82b may automatically be performed by a control device (not illustrated) of the crack detection vehicle 80. That is, control of the crack detection vehicle 80 is performed by a control device realized by, e.g., a computer or dedicated hardware installed on the operation floor, and a function of performing the automatic correction based on the detection results of the individual air tubes may be implemented in the crack detection vehicle 80.

### Other Embodiment

Although some embodiments of the present invention have been described, these embodiments are merely illustrative and do not limit the scope of the invention. These novel embodiments can be implemented in other various forms, and various abbreviations, exchanges, and changes can be made within a scope not deviating from the essence of the invention. These embodiments and their modifications are included in the scope and essence of the invention, and are included in the invention described in the claims, and the equal scope thereof.

For example, the crack detection vehicle provided with the checkout/inspection sensor 30 and another element is employed in the above fourth to eighth embodiments; however, the individual elements described in the fourth to eighth embodiments may appropriately be combined so as to be provided in the crack detection vehicle.

Further, the signal multiplexing unit 50 of the second embodiment or carrying vehicle 52 of the third embodiment may be employed in each of the fourth to eighth embodiments.

Further, although descriptions have been made with the shroud of a boiling-type reactor as an application target of the invention, the application target is not limited to this. For example, the present invention may be applied to a reactor core vessel of a pressurized-water reactor.

What is claimed is:

1. An in-reactor work system comprising:
a traveling mechanism traveling in a circumferential direction along an outer surface of a cylindrical structure which is disposed inside a reactor pressure vessel with its axis oriented in a vertical direction;
a work unit mounted in the traveling mechanism and performing work for the cylindrical structure;
an installation unit setting an initial position of the traveling mechanism on the cylindrical structure;
a mounting/removing mechanism mounting/removing the traveling mechanism and installation unit to/from each other; and
a carrying unit carrying the installation unit mounting the traveling mechanism inside the reactor pressure vessel,
the installation unit being capable of setting the traveling mechanism at the initial position in such a manner as to rotatably change an attitude of the traveling mechanism about a given horizontal axis depending on whether the traveling mechanism at the initial position on the outer surface of the cylindrical structure moves in the clockwise or counterclockwise direction.

2. The in-reactor work system according to claim 1, wherein
the traveling mechanism includes at least a frame body, a traveling portion traveling the frame body along the outer surface of the cylindrical structure, and an adsorbing portion forming a flow directed from the cylindrical structure side of the frame body to a rear side thereof during the travelling to cause the frame body to be adsorbed to the outer surface of the cylindrical structure.

3. The in-reactor work system according to claim 1, wherein
the traveling mechanism further includes a first depth sensor measuring water depth during the traveling.

4. The in-reactor work system according to claim 3, wherein
the traveling mechanism further includes a second depth sensor, the second depth sensor being disposed on the rear side relative to the first depth sensor in the travel direction of the traveling mechanism traveling from the initial position.

5. The in-reactor work system according to claim 4, comprising a correcting portion correcting a displacement in the travel direction of the traveling mechanism based on comparison between detection results of the first and second depth sensors.

6. The in-reactor work system according to claim 4, wherein
the traveling mechanism further mounts third and fourth depth sensors,
the first, second, third, and fourth depth sensors are each an air tube detecting water pressure,
the first and second depth sensors are opened downward in an attitude where the traveling mechanism travels in the clockwise direction from the initial position, and
the third and fourth depth sensors are opened downward in an attitude where the traveling mechanism travels in the counterclockwise direction from the initial position.

7. The in-reactor work system according to claim 1, wherein
the traveling mechanism further mounts at least two rollers on a surface of the frame body, the surface being orthogonal to the rear surface thereof and parallel to the travel direction.

8. The in-reactor work system according to claim 1, wherein
the installation unit is capable of incorporating the traveling mechanism and a cable connected to the traveling mechanism and includes a developing arm mechanically bringing the traveling mechanism into pressure contact with the cylindrical structure, an elevating portion setting a vertical position relative to the cylindrical structure, and cabling means feeding and housing the cable according to a traveling state of the traveling mechanism.

9. The in-reactor work system according to claim 8, comprising a signal multiplexing unit at the lower portion of the installation unit.

10. The in-reactor work system according to claim 1, wherein
the carrying unit has an underwater hoist and an overhead crane which are capable of being remotely operated.

11. The in-reactor work system according to claim 1, wherein
the carrying unit is a remotely-operable carrying vehicle capable of traveling underwater.

12. An in-reactor work method that performs work, during shutdown of a nuclear reactor in which a cylindrical structure disposed inside a reactor pressure vessel with its axis oriented in vertical direction, by making a work unit mounted in a traveling mechanism travel along an outer surface of the cylindrical structure, the method comprising:
a carrying step of carrying the installation unit removably mounting the traveling mechanism from above the reactor pressure vessel in a state where the upper portion of the reactor pressure vessel is opened and the reactor pressure vessel is filled with water;
a setting step of setting an initial position of the traveling mechanism on the outer surface of the cylindrical structure;
a removing/mounting step of removing/mounting the traveling mechanism from the installation unit; and
a working step of allowing the work unit to perform work by making the traveling mechanism travel along the outer surface of the cylindrical structure.
